(19) United States
(12) Patent Application Publication
(10) Pub. No.: US 2009/0031637 A1
(43) Pub. Date: Feb. 5, 2009

(54) COATED ABRASIVES

(76) Inventors: David Patrick Egan, Kilkishen (IE); Johannes Alexander Engels, Newport (IE); Michael Lester Fish, Ballaghboy (IE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/244,786

(22) Filed: Oct. 3, 2008

Related U.S. Application Data
(62) Division of application No. 10/585,936, filed on Apr. 27, 2007.

(30) Foreign Application Priority Data
Jan. 15, 2004 (IE) S2004/0027

(51) Int. Cl. B24D 3/04; C09K 3/14

(52) U.S. Cl. 51/309; 51/295

(57) ABSTRACT

This invention relates to coated abrasives, a process for their production, and to coated abrasives for use in abrasive-containing tools.

### BACKGROUND OF THE INVENTION

This invention relates to coated abrasives, a process for their production, and to coated abrasives for use in abrasive-containing tools.

Abrasive particles such as diamond and cubic boron nitride are commonly used in cutting, grinding, drilling, sawing and polishing applications. In such applications, abrasive particles are mixed with metal powder mixes, then sintered at high temperatures to form bonded cutting elements. Typical bond matrices contain iron, cobalt, copper, nickel and/or alloys thereof.

Common problems in applications are retention of particles in the bond matrix, and resistance against oxidative and chemical attack during the sintering process and the subsequent application.

These problems are commonly addressed by coating the abrasive particles with metals or alloys which bond chemically to the particle, and alloy to the bond matrix. Typically, chemical vapour deposition (CVD) or physical vapour deposition (PVD sputter coating) techniques are used. Titanium carbide is an example of a material that has been proposed as a coating for abrasive particles, because of its good adhesion to diamond. Chromium carbide is a similar coating material that can be used.

A problem with the use of titanium carbide coatings where the bond matrix contains bronze or Cu is that these materials tend to react with the titanium carbide, such that it may be reacted away. The diamond particles are then susceptible to graphitisation of the diamond particle surfaces, where the bond matrix consists of metals that are typically used as solvent/catalysts for diamond synthesis. Examples of such metals are Fe, Co and Ni. In the molten state, these metals are capable of dissolving diamond, which precipitates to form graphite. This process of graphitisation of the diamond surface not only weakens the particles but may also result in poorer retention of the particles in the bond.

During manufacture of cutting tools, for example during sintering of saw segments containing diamond particles, oxygen may be present as surface oxides, dissolved oxygen in the metal powders that form the bond matrix, or in gaseous form in the atmosphere or as a consequence of application of the titanium carbide coating itself. At the sintering temperatures this oxygen is liable to attack the surface of the diamond particles, which weakens the particles.

Further, loss of diamond particles from the bond matrix by pull-out of the particles is a common reason for loss of performance, caused by poor adhesion of the particles to the bond matrix. If the particles are coated, then adhesion between the particle and the coating, as well as adhesion between the coating and the bond matrix, play an important role in retaining the particle in the bond. If either interface is weak, particle pull-out occurs.

### SUMMARY OF THE INVENTION

A coated super-hard abrasive comprising a core of super-hard abrasive material, an inner layer of a metal carbide, nitride, boride, boronitride or carbonitride chemically bonded to an outer surface of the super-hard abrasive material and one or more outer layers of a metal carbide, nitride, boride or carbonitride physically deposited on the inner layer, wherein in the case of a single outer layer, the single outer layer has a composition gradient extending through its thickness, and in the case of more than one outer layer, the composition of each layer is different to provide a gradient of material through the various layers.

In the case of several outer layers, each layer may also include a composition gradient.

The outer layer(s) is/are preferably applied by physical vapour deposition.

The ultra-hard abrasive material is typically diamond or cBN based, and may include diamond or cBN grit, PCD substrates, thermally stable PCD (TSPCD) substrates, PcBN substrates, CVD diamond film, single crystal diamond substrates.

The inner layer is formed from an element capable of forming (singly or in combination) carbides, nitrides or borides to the surface(s) of the abrasive material when applied as an inner layer using a hot coating process. Typically these elements come from groups IVa, Va, VIa, IIIb and IVb of the periodic table. The inner layer is preferably a titanium or chromium carbide coating in the case of a diamond abrasive core, or a titanium or chromium nitride or boride coating in the case of a cBN abrasive core, although other metals such as vanadium, molybdenum, tantalum, indium, zirconium, niobium, tungsten, aluminium, boron and silicon, for example, could also be used.

The outer layer(s) is/are comprised (whether singly or in combination) of carbides, nitrides, borides, oxides or silicides of metals from groups IVa, Va, VIa, such as titanium and chromium, from groups IIIb and IVb, such as aluminium, or elements such as boron and silicon, but is/are preferably comprised of titanium carbide, titanium carbonitride, titanium nitride, titanium boride, or titanium boronitride.

The gradients between the metals, the metal(s) and the non metal(s) and between the non metals can be varied either continuously (producing gradients) or discontinuously (producing multiple layers) in order to tailor the physical and chemical properties of the outer layer. For example, where the outer coating layer is titanium carbide, the ratio of Ti to C can be varied to provide the composition gradient. In the case of titanium carbonitride, both the Ti:(C,N) and C:N ratios can be varied.

### DESCRIPTION OF PREFERRED EMBODIMENTS

Whilst the invention extends to various forms of coated abrasive material, it will in the most part be described with reference to the coating of diamond grit for convenience.

Ti in the form of titanium carbide or titanium nitrides and borides have been shown to be useful coating materials for diamond and cBN substrates, respectively. They are particularly useful because of their ability to bind chemically to the substrate and to protect the substrate. However, as has been mentioned previously, they are not suitable in some applications, particularly where they are sintered in aggressive sintering conditions in the presence of bronze or copper, and where the bond matrix contains ferrous metals, for example. They are also often subject to pull-out problems.

It has been found that the advantages of Ti coatings can be extended to other applications utilising diamond grit where an outer coating of a titanium carbide, carbonitride, boride or nitride having a composition gradient is applied over the titanium coating layer. This is particularly the case where diamond grit is used in a metal bond matrix containing ferrous metals to form an abrasive tool component upon sintering. It is also useful where the titanium carbide coating, in the case of diamond particles, would be reacted away by a constituent of the metallic material, for example bronze and copper brazing of the material to another metallic or ceramic material, or sintering or infiltrating a powder to form an infiltrated powder material. It also allows for better bonding with the bond matrix

It is especially useful in the making of diamond impregnated tools such as segments for saw blades, drills, beads for diamond wires especially where high amounts of bronze or copper limit the usefulness of titanium carbide coatings, the making of brazed diamond layer tools such as brazed diamond wire beads, the making of diamond containing metal matrix composites, brazing of diamond materials such as affixing TSPCD, PCD and diamond drillstones to a drill body, affixing CVD, monocrystal, TSPCD and PCD to a saw blade, tool post, drill body and the like.

Additionally, the coated diamond impregnated tools yield improved performance such as longer tool life and higher productivity. Coated diamond particles of the invention for brazing applications allow the use of simple brazes that work in air as opposed to active brazes containing Ti which require the exclusion of oxygen.

The coated abrasive particles are preferably formed using a hot coating process for applying the inner layer and a PVD process for applying the outer layer.

The diamond grit particles are those used conventionally in the manufacturing of metal bonded tools. They are generally uniformly sized, typically 0.1 to 10 mm. Examples of such diamond grit particles include: Micron grit 0.1 to 60 micron, wheel grit 40 micron to 200 micron, saw grit 180 micron to 2 millimeter, mono crystal 1 millimeter to 10 millimeter, CVD inserts of a few square millimeter to discs up to 200 millimeter diameter, PCD inserts of a few square millimeter to discs 104 millimeter diameter, cBN grit in micron range 0.1 to 60 micron, in wheel grit range 40 micron to 200 micron, PCBN inserts of a few mm to discs up to 104 mm diameter.

The diamond particles are first coated in a hot coating process to provide an inner layer, which may be a metal layer or a metal carbide, nitride or carbonitride layer. In the case of cBN, such inner coating would typically be a metal nitride or boride or boronitride layer. In this hot coating process, the metal-based coat is applied to the diamond substrate under suitable hot conditions for such bonding to take place. Typical hot coating technologies that can be used include processes involving deposition from a metal halide gas phase, CVD processes, or thermodiffusion vacuum coating or metal vapour deposition processes, for example. Deposition from a metal halide gas phase and CVD processes are preferred.

In processes involving deposition from a metal halide gas phase, the particles to be coated are exposed to a metal-halide containing the metal to be coated (e.g. Ti) in an appropriate gaseous environment (e.g. non-oxidising environments containing one or more of the following: inert gas, hydrogen, hydrocarbon, reduced pressure). The metal halide may be generated from a metal as part of the process.

The mixture is subjected to a heat cycle during which the metal-halide transports the Ti to the surfaces of the particles where it is released and is chemically bonded to the particles.

The outer layer is deposited using a cold coating technique such as PVD, which is preferred. It is a low temperature process in that insufficient heat is generated to cause significant carbide formation. Hence, if used alone, it would result in relatively poor adhesion to the diamond particles. An example of a PVD process for applying the outer coating is reactive sputter coating. It can be used to apply a single outer coating with a composition gradient, or to apply several outer coatings of different compositions to provide the composition gradient. Each of these outer coating layers could also have composition gradients themselves. In this method, the Ti:C, Ti:(C,N) or C:N, as the case may be, can be tailored to provide the composition gradient and in so doing form better bonds with the bond matrix.

Examples of coated abrasive of the invention include:

On diamond coated with titanium carbide applied by a hot process, such as the commercially available SDBTCH, a second layer of:
i) Titanium nitride;
ii) Titanium carbonitride;
iii) Titanium aluminium nitride;
iv) Titanium aluminium carbonitride coating.

The above examples provide increasing chemical resistance in the above sequence (and increasing heat resistance as the Al content increases). TiAlCN coatings are said to be “universal coatings” and have large scope for tailoring properties.

This invention will now be described, by way of example only, with reference to the following non-limiting examples.

### EXAMPLE 1

Diamond grit from Element Six, 40/45 US mesh size, was coated in a CVD process to produce TiC coated diamond according to general methods commonly known in the art. The CVD TiC coated diamond was then used as the substrate for the second coating step.

1,000 carats of this TiC coated diamond, 40/45 US mesh size, was placed in a magnetron sputter coater with a rotating barrel and a large pure titanium metal plate as the target. The coating chamber was evacuated, argon was admitted and the power turned on to form plasma. Sputtering power was increased to 10 A (400V) on target while rotating the barrel to ensure an even coating on all the diamond particles at 20 sccm argon pressure. Methane gas was admitted to achieve an Optical Emission Measurement of 50%, and coating continued for 30 minutes. Subsequently, coating using methane gas was continued at an Optical Emissions Measurement of 60% for a further 30 minutes. Coating using methane gas was continued at an Optical Emissions Measurement of 70% for a further 30 minutes. Coating using methane gas was continued at an Optical Emissions Measurement of 80% for a further 30 minutes. Coating using methane gas was continued at an Optical Emissions Measurement of 90% for a further 30 minutes. Finally, coating only with argon was continued for 40 minutes. The total coating time was 190 minutes. The coated diamond was allowed to cool before removing from the chamber.

An analysis of this coated diamond was undertaken, consisting of X-ray diffraction, X-ray fluorescence, Chemical assay of the coating, Optical and Scanning Electron Microscopy image analysis, and particle fracture followed by cross-sectional analysis on the SEM.

Visually, this coating appeared to have a dark grey metallic colour. The coating looked uniform and relatively smooth and without any uncoated areas. Observation on the SEM showed an even coating with a somewhat rough morphology. A two-layer structure was evident but only by a difference in microstructure, the complete layer having a thickness of about 0.8 to 1 micron. This particular coating resulted in an assay of 1.76%. The TiC coating in this size used for this batch typically has an assay of 0.77%. The rest of the 1.76% is therefore attributable to the PVD TiC and Ti metal layer on top of the CVD TiC. When analysed using XRD, TiC and Ti metal were found. XRF analysis showed 100% Ti.

### EXAMPLE 2

CVD TiC coated diamond, produced in a first coating step as described in Example 1, was used as the substrate for the second coating step. 1,000 carats of this TiC coated diamond, 40/45 US mesh size, was placed in a magnetron sputter coater with a rotating barrel and a large pure titanium metal plate as the target. The coating chamber was evacuated, argon was admitted and the power turned on to form plasma. Sputtering power was increased to 10 A (400V) on target while rotating the barrel to ensure an even coating on all the diamond particles at 20 sccm argon pressure. Methane gas was admitted to achieve an Optical Emission Measurement of 50%. While continuing coating the Optical Emissions Measurement was increased gradually to 100% in 165 minutes. Coating without using methane was continued for 30 minutes. The total coating time was 195 minutes. The coated diamond was allowed to cool before removing from the chamber.

An analysis of this coated diamond was undertaken, consisting of X-ray diffraction, X-ray fluorescence, Chemical assay of the coating, Optical and Scanning Electron Microscopy image analysis, and particle fracture followed by cross-sectional analysis on the SEM.

Visually, this coating appeared to have a dark grey metallic colour. The coating looked uniform and smooth and without any uncoated areas. Observation on the SEM showed an even coating with a somewhat rough morphology. A two-layer structure was evident but only by a difference in microstructure, the complete layer having a thickness of about 1 micron. This particular coating resulted in an assay of 1.8%. The TiC coating in this size used for this batch typically has an assay of 0.77%. The rest of the 1.8% is therefore attributable to the PVD TiC and Ti metal layer on top of the CVD TiC. When analysed using XRD, TiC and Ti metal were found. XRF analysis showed 100% Ti.

### EXAMPLE 3

CVD TiC coated diamond, produced in a first coating step as described in Example 1, was used as the substrate for the second coating step. 1,000 carats of this TiC coated diamond, 40/45 US mesh size, was placed in a magnetron sputter coater with a rotating barrel and a large pure titanium metal plate as the target. The coating chamber was evacuated, argon was admitted and the power turned on to form plasma. Sputtering power was increased to 10 A (400V) on target while oscillating the barrel to ensure an even coating on all the diamond particles at 20 sccm argon pressure. Coating with titanium metal continued at 2 kW (420V, 10 Amps) for 30 minutes. Methane gas was admitted to achieve an Optical Emission Measurement of 60%. This was continued for 30 minutes. Methane admission was stopped, and coating with titanium metal alone continued for 30 minutes. Methane gas was again admitted to achieve an Optical Emission Measurement of 60%. This was continued for 30 minutes. Lastly, methane admission was stopped, and coating with titanium metal continued for 30 minutes. The total coating time was 150 minutes. The coated diamond was allowed to cool before removing from the chamber.

An analysis of this coated diamond was undertaken, consisting of X-ray diffraction, X-ray fluorescence, Chemical assay of the coating, Optical and Scanning Electron Microscopy image analysis, and particle fracture followed by cross-sectional analysis on the SEM.

Visually, this coating appeared to have a dark grey metallic colour. The coating looked uniform and smooth and without any uncoated areas. Observation on the SEM showed an even coating with a somewhat rough morphology. A two-layer structure was evident but only by a difference in microstructure, the complete layer having a thickness of about 0.8 to 1 micron. This particular coating resulted in an assay of 1.4%. The TiC coating in this size used for this batch typically has an assay of 0.77%. The rest of the 1.4% is therefore attributable to the PVD TiC and Ti metal layer on top of the CVD TiC. When analysed using XRD, TiC and Ti metal were found. XRF analysis showed 100% Ti.

1-10. (canceled)

11. A diamond containing body which is a diamond impregnated tool, a tool containing brazed diamond or a diamond containing metal matrix composite, comprising
a metal matrix; and
a coated diamond abrasive comprising a core of diamond abrasive material, an inner layer of a metal carbide, nitride, boride, boronitride or carbonitride chemically bonded to an outer surface of the diamond abrasive material and one or more outer layers of a metal carbide, nitride, boride or carbonitride physically deposited on the inner layer, wherein in the case of a single outer layer, the single outer layer has a composition gradient extending through its thickness, and in the case of more than one outer layer, the composition of each layer is different to provide a gradient of material through the various layers, wherein the outer-layer of the coated diamond abrasive is attached to the metal matrix of the diamond containing body.

12. The diamond containing body according to claim 11, further comprising a bond matrix containing copper, bronze or a ferrous metal.

13. The diamond containing body according to claim 11, which is a segment for a saw blade, drill body, tool post or bead for a diamond wire.

14. The diamond containing body according to claim 11, wherein the coated diamond abrasive comprises several outer layers, each layer including a composition gradient

15. The diamond containing body according to claim 11, wherein the outer layer of the coated diamond abrasive comprises more than one layer, each layer being different to provide a gradient of material through the layers.

16. The diamond containing body according to claim 11 wherein the diamond abrasive material is a PCD substrate, a thermally stable PCD (TSPCD) substrate, a CVD diamond film, or a single crystal diamond substrate.

17. The diamond containing body according to claim 11, wherein the inner layer of the coated diamond abrasive is formed from an element capable of forming, singly or in combination, carbides, nitrides or borides to the surface(s) of the abrasive material when applied in a hot coating process.

18. The diamond containing body according to claim 17, wherein the element is from IVa, Va, VIa, IIIb or IVb of the periodic table.

19. The diamond containing body according to claim 11, wherein the inner layer of the coated diamond abrasive is a titanium or chromium carbide.

20. The diamond containing body according to claim 11, wherein the outer layer of the coated diamond abrasive comprises a carbide, a nitride, or a boride of metals from groups IVa, Va, VIa, IIIb or IVb of the periodic table.

21. The diamond containing body according to claim 11, wherein the outer layer(s) is/are comprised of titanium carbide, titanium carbonitride, titanium nitride, titanium boride, or titanium boronitride.

22. The diamond containing body according to claim 12, wherein the outer layer(s) Is/are comprised of titanium carbide, titanium carbonitride, titanium nitride, titanium boride, or titanium boronitride.
